(19) United States
(12) Patent Application Publication
(10) Pub. No.: US 2025/0156779 A1
(43) Pub. Date: May 15, 2025

(54) ARTIFICIAL INTELLIGENCE ROUTE-BASED VEHICLE SENSOR EVALUATION

(71) Applicant: AirWire Technologies, Reno, NV (US)

(72) Inventors: Gerardo Gonzalez, Allen, TX (US); Debashis Bagchi, Reno, NV (US)

(21) Appl. No.: 19/026,051

(22) Filed: Jan. 16, 2025

Related U.S. Application Data
(62) Division of application No. 16/940,173, filed on Jul. 27, 2020.
(60) Provisional application No. 62/878,703, filed on Jul. 25, 2019.

(51) Int. Cl. G06Q 10/0631; G06Q 10/1093; G07C 5/00; G07C 5/08

(52) U.S. Cl. CPC G06Q 10/06312; G06Q 10/06315; G06Q 10/1095; G07C 5/006; G07C 5/008; G07C 5/0808

(57) ABSTRACT

An intelligent vehicle assistant consistent with the present disclosure may collect user preferences, user data, and data associated with a vehicle when providing information or instructions to a person in the vehicle by sending messages to a vehicle computer. The vehicle assistant may acquire preferences or data from the vehicle via a wired diagnostic port or via a wireless communication interface. Queries from a person may be received by the vehicle computer and may be sent to the intelligent vehicle assistant that interprets those commands and that evaluates contextual information to identify and send responses to the queries that may be provided to the person via an audio interface or via a display. These query responses may be based on a current context of the vehicle and past behaviors of the person.

### CROSS-REFERENCES TO RELATED APPLICATIONS

The present application is a divisional and claims the priority benefit of U.S. application Ser. No. 16/940,173, filed Jul. 27, 2020, which claims the priority benefit of U.S. Provisional Application No. 62/878,703, filed Jul. 25, 2019, the disclosures of which are incorporated herein by reference in their entirety.

### BACKGROUND OF THE INVENTION

### Field of the Disclosure

The present disclosure is generally related to intelligent virtual assistants that provide responses or recommendations to persons via a user interface at a vehicle. More specifically, the present disclosure is directed to adjusting the operation of an intelligent virtual assistant based on contextual information received from both the vehicle and the person.

### Description of the Related Art

There are presently no available artificial intelligence (AI) based vehicle assistants that respond to queries from users based on collected user data and sensor data sensed by sensors at a vehicle.

As such, it is desirable to have an AI-based vehicle assistant that can provide responses or recommendations to drivers of a vehicle while the operation of a vehicle is monitored. What are needed are AI assistants that can collect data associated with a vehicle and that can respond to queries from the driver to improve the driving experience.

### SUMMARY OF THE PRESENTLY CLAIMED INVENTION

The presently claimed invention relates to a method, a non-transitory computer-readable storage medium, and an apparatus that evaluates data. A first embodiment of the presently claimed invention is a method that receives a command from a vehicle computing device, retrieves data associated with the command, identifies a response to provide to a person at the vehicle, and sends a communication to the vehicle computer device that includes the response. The vehicle computing device may then receive the communication and provide the response to the person via a user interface at the vehicle.

A second embodiment of the presently claimed invention is a non-transitory computer-readable storage medium where a processor executes instructions to perform the presently claimed method. Here again the method may include receiving a command from a vehicle computing device, retrieving data associated with the command, identifying a response to provide to a person at the vehicle, and sending a communication to the vehicle computer device that includes the response. The vehicle computing device then receives the communication may then provide the response to the person via a user interface at the vehicle.

A third embodiment of the presently claimed invention is an apparatus that includes a memory and a processor. The processor may execute instructions out of the memory to receive a command from a vehicle computing device, retrieve data associated with the command, identify a response to provide to a person at the vehicle, and prepare a communication to be sent to the vehicle computer device that includes the response. The communication may then be sent to and received by the vehicle computing device and the vehicle computing device may then provide the response to the person via a user interface at the vehicle.

### BRIEF DESCRIPTIONS OF THE DRAWINGS

FIG. 1 illustrates an intelligent vehicle assistant that may receive vehicle data and user queries when identifying responses or recommendations to provide to a person in a vehicle.

FIG. 2 illustrates steps that may be performed by a processor when instructions of a vehicle artificial intelligence (AI) network are performed.

FIG. 3 illustrates a series of steps that may be performed when instructions of a base software module are executed by the processor of the vehicle AI agent of FIG. 1.

FIG. 4 illustrates steps that may be performed when instructions of the vehicle I/O module are executed by the processor of the vehicle AI agent of FIG. 1.

FIG. 5 illustrates steps that may be performed when instructions of the user software module are executed by the processor of the vehicle AI agent of FIG. 1.

FIG. 6 illustrates operations that may be performed when instructions of the command software module are executed by the processor of the vehicle AI agent of FIG. 1.

FIG. 7 illustrates steps that may be performed when instructions of a use case software module are executed by the processor of the vehicle AI agent of FIG. 1

FIG. 8 illustrates a computing system that may be used to implement an embodiment of the present invention.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

An intelligent vehicle assistant consistent with the present disclosure may collect user preferences, user data, and data associated with a vehicle when providing information or instructions to a person in the vehicle by sending messages to a vehicle computer. The vehicle assistant may acquire preferences or data from the vehicle via a wired diagnostic port or via a wireless communication interface. Commands from a person may be received by the vehicle computer and may be sent to another device that interprets those commands and that evaluates contextual information to identify and send responses to the commands that may be provided to the person via an audio interface or via a display.

The vehicle computer may include a voice assistant that receives voice messages from a driver of the vehicle, may collect sensor data, and may monitor the behaviors of the driver. Additionally or alternatively, the vehicle computer may also receive input from a user interface (e.g. a graphical user interface). Queries and other information received by the vehicle computer may be provided to an external computing device that may adjust responses to those queries based on the current context of the vehicle and a past behavior or preferences of the driver.

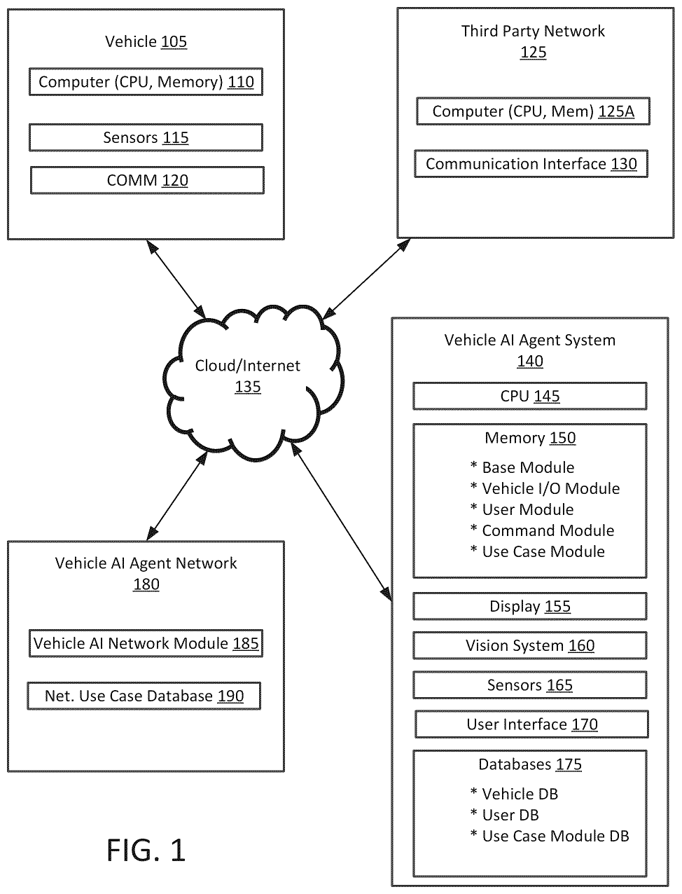

FIG. 1 illustrates an intelligent vehicle assistant that may receive vehicle data and user queries when identifying responses or recommendations to provide to a person in a vehicle. This system comprises of a Vehicle 105, which is generally a machine that transports people or cargo from one place to another. Examples of vehicles include a car, a motorcycle, a truck, a boat, aircraft, or a bicycle. Vehicle computer 110 is a machine that is located within or on a vehicle 105 that includes a processor (CPU) and a memory, where the memory stores instructions that allow the vehicle computer of being programmed to carry out logical operations. Sensors 115 may collect data associated with the operation of vehicle 105 and these sensors may provide data to computer 110 when the computer 110 executes instructions of a software program module to detect events or changes in an environment. Sensors 115 may include tire pressure sensors, temperature sensors, fluid level sensors (that sense levels of fuel, oil, hydraulic fluid, windshield wiper fluid, coolant, etc.), oxygen sensors, ultrasonic sensors, Lidar sensors, speed sensors, cameras, optical sensors, and/or other sensors. FIG. 1 illustrates a communication interface or device (vehicle COMM) 120 located inside or on the vehicle 105. This communication device 120 may allow vehicle computer 110 to send and/or receive information from vehicle 105 to other devices. Vehicle COMM 120 may take the form of a physical connection, such as a port to connect to the vehicle on-board diagnostic (OBD) system. Alternatively, the vehicle COMM 120 may send and receive information via electromagnetic waves, such as a radio transmitter, a WIFI connection, a cellular communication system (3G, 4G, 5G, or other), a global positioning system, or a Bluetooth connection. Cloud or Internet 135 may allow computer 110 at vehicle 105 to communicate with third party network computer 125A via COMM 120 of vehicle 105 and communication interface 130 of third party network 125. Third party network 125 may be a digital communication network that sends, receives, and stores information related to the user activity and preferences. Third party network 125 may store or track vehicle specifications, external conditions, or other information that may relate to, for example, vehicle manufacturing, part manufacturing, accident records, insurance, social media preferences, retail shopping history, traffic conditions, weather conditions, fuel prices and customer loyalty programs. Vehicle artificial intelligence (AI) agent network 180 may be a digital communication network that sends, receives, and stores information related to the activities of a vehicle AI agent. Vehicle AI agent network may include a computer (not illustrated) that executes instructions of vehicle network module 185, these instructions may allow the computer at vehicle AI agent network 180 to receive user requests from a use case software module. Instructions of this use case software module may retrieve appropriate data from the network use case database 190 of FIG. 1. The network use case database 190 is an organized collection of data pertaining to possible user requests made to the vehicle AI agent and the appropriate data and actions that correspond to such requests.

Vehicle AI agent system 140 is a collection of electronic devices, routines/instructions, and storage systems that send and receive user requests related to a vehicle, stores past requests, and performs operations as required. The vehicle AI agent system 140 includes a computer that includes processor/CPU 145, memory 150, and display 155. The CPU 145 at the vehicle AI agent system 140 may be capable of being programmed to execute instructions stored in memory 150 and access data stored at databases 175 of the vehicle AI agent system 140 of FIG. 1. The various databases at vehicle AI agent system 140 include vehicle database 128 that stores a collection of data related to a vehicles current status (for example, tire pressure, fuel and fluids levels, recent service dates) as well as general information about the vehicle (for example, a VIN number, a vehicle make, and a vehicle model, recommended parts, and service schedule, etc.). Sensors 165 may be designed to sense data that may be used to identify events of changes in an environment. Exemplary sensors include an accelerometer, a camera, and vision system 160. Vision system 160 may be a collection of devices and software instructions that allow an electronic device to analyze visual or environmental data. Display 155 may be a device for outputting and presenting information to a user, for example, an LED screen or a microphone. User interface 170 may be a collection of devices and software instructions that allow a user to interact with an electronic device, for example, a voice recognition system or a graphical user interface.

The user database of databases 175 may be an organized collection of data pertaining to user preferences. This data may include information input by a user. Data input by a user may include a home location, a work location, preferred retailers, schedule information, or other information. This user database may also store data collected about normal routines of the user (i.e., frequently visited locations, route preferences, etc.) and data collected from third parties (i.e., retail locations along routes, customers loyalty and sale offers, preferences from social media, etc.). Preference data may be stored at the user case module database of vehicle AI agent system 140 or may be stored at the network use case database 190 of the vehicle AI agent network 180. Preference data may be received from a user via a user computing device or may be received from third party network computer 125A. This preference data may identify a brand of gasoline that is preferred by a user, a store or coffee shop preferred by a user, roads preferred by a user, service recommendations received from a computer of a vehicle manufacturer, or may include other data.

The use case module database of databases 175 may store an organized collection of data related to the information that should be collected and actions that should be performed in response to specific user requests. Memory 150 of the Vehicle AI agent system 140 is illustrated as storing instructions of several modules that may work together to receive user commands and queries related to a vehicle and its use. The software modules of memory 150 include a base modules, a vehicle I/O module, a user module, a command module, and a use case module. Operation of these software module instructions may allow CPU 145 to retrieve appropriate data from various sources, to perform required actions, and to return appropriate responses—similar to other context-based search systems well known in the art.

The base software module stored in memory 150 may include instructions used to organize commands and CPU 145 may execute instructions of one or more additional software modules, as necessary. Instructions of the specific modules executed may be identified based on a nature of a user request or a category associated with a user request. Vehicle I/O software module may include instructions that result in CPU 145 receiving data from computer 110 at vehicle 105. This received data may be stored in the vehicle database at the vehicle AI agent system 140. In an instance when a user requests information pertaining to whether their vehicle has enough gas to reach a certain destination, software instructions at the vehicle AI agent system 140 may cause CPU 145 to identify a fuel level from vehicle's fuel level sensor data. Instructions associated with the user module may cause CPU 145 to detect that a command has been received and this may result in CPU 145 executing instructions that provides the command to the use case software module and the command software module. The command module stored in memory 150 may include instructions that cause CPU 145 to evaluate received commands, determine actions that may be associated with those commands, and perform those actions. For example, if a user requests information pertaining to whether their vehicle has enough gas to reach a certain destination, instructions of the command module may cause CPU 145 to calculate a maximum number of miles that can be traveled based on the information provided by the vehicle (e.g. fuel level and average gas mileage). Once an estimate of the number of miles that can be traveled has been identified, this information may be sent to computer 110 at vehicle 105 after which that information may be provided to a driver of vehicle 105 via a user interface (e.g. a display or speaker).

Instructions of the use case module stored in memory 150 may include instructions that allow CPU 145 to detect and evaluate commands may cause data to be retrieved from the use case database, and that may allow CPU to store updates and projections in the use case database at the vehicle AI agent system 140 of FIG. 1.

One skilled in the art will appreciate that, for this and other embodiments disclosed herein, the elements associated with the system for the Vehicle Intelligent Assistant are exemplary in nature. Some of the elements may be combined into fewer elements, or expanded into additional elements without detracting from the disclosed embodiments. Furthermore, some of the elements of the methods and apparatus consistent with the present disclosure may be optional and others may be added also without detracting from how the vehicle intelligent assistant functions.

While FIG. 1 illustrates the vehicle AI agent system as being remote from vehicle 105, operations performed by the vehicle AI agent system may be performed by computer 105 of vehicle 105 or another computing device at vehicle 105. As such, operations performed by the base software module, the vehicle I/O software module, user software module, command software module, and the use case software module may be performed by a computing device at vehicle 105. Furthermore, the various databases 175, display 155, vision systems 160, sensors 165, and user interface 170 may reside in or on vehicle 105 of FIG. 1. Reference to any intermediary network (like that of FIG. 1) should be considered inclusive rather than exclusive and representative of various network componentry that might be found interconnecting various elements of the vehicle 105 and computing systems therein.

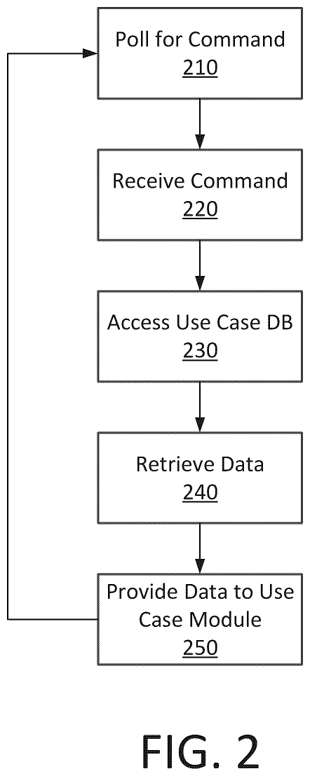

FIG. 2 illustrates steps that may be performed by a processor when instructions of a vehicle artificial intelligence (AI) network are performed. The steps of FIG. 2 may be implemented by processor that executes instructions of AI software network software module 185 of FIG. 1. Functioning of the vehicle network module will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The process of FIG. 2 begins with polling for a command from the use case module, at step 210. Instructions of the vehicle AI agent network module may cause a command from the use case module to be received, at step 220 of FIG. 2. The network use case module database 190 may then be accessed or polled for the appropriate action request(s) and/or information, at step 230. Next in step 240 of FIG. 2, the vehicle AI agent network module may retrieve appropriate data from the network use case module database. This data may then be sent or provided to the use case module within the vehicle AI agent system 140, at step 250. After step 250, program flow may move back to step 210 of FIG. 1, where additional commands may be received or polled for.

Instructions of the vehicle network module of FIG. 2 may, thus, allow a processor to receive commands, access an appropriate database to retrieve appropriate data, and then store that data in memory such that instructions associated with another software module may cause a processor to perform certain specific actions according to the received commands.

Table 1 illustrates data that may be stored at a network use case database, such as database 190 of FIG. 1. The use case database may store all of the commands possible for the system 140 of FIG. 1 is programmed to act upon. Table 1 includes a first column that contains the command identification (CMD ID) numbers, a second column contains sample voice requests that are associated with a given command, a third column contains information/data relevant to the command, a fourth column contains a first action (e.g., action 1) to be performed in association with the given command, a fifth column contains a second action (e.g., action 2) to be performed in association with the given command, a sixth column contains a third action (e.g., action 3) to be performed in association with the given command, and a seventh column contains a fourth action (e.g., action 4) to be performed in association with the given command.

A first row in table 1 identifies that a first command (CMD ID 1) is associated with a voice request that asks “what is my schedule?” and a number of actions that may be performed to service that command. The actions associated with command 1 are retrieve data from the user database, retrieve traffic conditions from a third party database, retrieve fuel levels from the vehicle computer, and calculate a recommended departure time based on a travel distance, road conditions, and fuel levels. The recommended departure time may be adjusted based on traffic conditions or based on an identification that the driver of the vehicle must stop for gas. Methods and apparatus consistent with the present disclosure may assist drivers by considering information that is required to reach a destination on time. Departure times may be moved to an earlier time when traffic is congested or upon an identification that that driver must stop for fuel.

Methods consistent with the present disclosure may cause the vehicle AI agent system 140 of FIG. 1 to collect data from computer 110 of FIG. 1, and from third party network 125 when identifying an appropriate response to a particular command. The vehicle AI agent system 140 may also communicate with the vehicle AI agent network when identifying use cases for particular drivers. This may allow the vehicle AI agent system to modify driver schedules according to driver preferences, based on traffic, or based on driving history.

The commands of table 1 may allow a driver of a vehicle to simply ask a question of “do I need to stop for gas?”; “what is my vehicle identification number (VIN)?”; or “when do I need an oil change.” After receiving such a question, the actions 1-4 may be performed and an answer may be provided to a driver via a user interface (e.g. a display or a speaker) at the vehicle. Depending upon the particular question, a processor executing instructions out of memory may access an appropriate computer system or database to collect information and determine a result to provide to a driver.

TABLE 1
Network Use Case Database Data

| | Sample Voice | | | | | |
|---|---|---|---|---|---|---|
| CMD ID | Request | Data | Action 1 | Action 2 | Action 3 | Action 4 |
| 1 | “What is my | | Retrieve | Retrieve traffic | Retrieve | Calculate |
| | schedule?” | | calendar | conditions from | fuel levels | recommended |
| | | | data from | 3^{rd} party database | from | departure |
| | | | user | | vehicle | time |
| | | | database | | | |
| 2 | “Do I need to | | Retrieve | Retrieve average | Calculate | |
| | stop for gas?” | | fuel levels | miles per gallon | trip | |
| | | | from | from vehicle | distance | |
| | | | vehicle | | possible | |
| | | | | | with | |
| | | | | | current | |
| | | | | | fuel levels | |
| 3 | “What is my | VIN = | | | | |
| | car's VIN | 123456789 | | | | |
| 4 | “When do I | | Retrieve | Retrieve oil | Retrieve | Retrieve |
| | need an oil | | oil change | change | odometer | preferred oil |
| | change?” | | records | recommendations | readings | change from |
| | | | from 3^{rd} | from 3^{rd} party | from | user database |
| | | | party | database | vehicle | |
| | | | database | | | |

Table 2 illustrates exemplary sets of data that may be stored in a vehicle database, such as the vehicle database of databases 175 of FIG. 1. The vehicle database of table 2 may store all available information about a vehicle. Table includes a first column that contains the date and time at which certain data was recorded (e.g., time stamp), a second column that contains a vehicle identification number, a third column that contains the manufacturer of the vehicle (e.g., make), a fourth column that contains the model of the vehicle, a fifth column that contains information about the vehicle's current fuel tank level, a sixth column that contains information about the oil changes performed on the vehicle, a seventh column that contains information a vehicles tire pressure, and an eighth column that contains the mileage of the vehicle.

The timing data stored in table 2 may cross-reference a date and a time to the various types of data collected over time for one or more vehicles. The first row of table 2 identifies that on May 6, 2018 at 12 noon, a vehicle ID number of 123456789 of a Toyota Prius was entered into the vehicle database. Over time fuel levels, tire pressures, and odometer readings that may have been collected from one or more vehicle sensors may be stored and cross-referenced with yet another date and time. Note also that on May 8, 2018 at 13:30 hours, that the vehicle fuel level was 12 gallons, that an oil change was performed where 4 quarts of synthetic oil were provided as part of an oil change service, and that the tire pressure was 31 pounds per square inch (psi) when the odometer reading of the vehicle was 32843 miles.

The information stored in the vehicle database of table 2 may have been collected by the vehicle AI agent system 140 of FIG. 1 via communications received from vehicle computer 110. Fuel level, tire pressure, and odometer readings may have been collected from sensor 115 data by computer 110. Computer 110 may have then sent this data to vehicle AI agent system 140 via COMM 120 and cloud/Internet 135. Oil change information may be collected from a computer of a third party oil change vendor or other service provider after or when the oil was changed.

TABLE 2
Vehicle Database Data

| | Vehicle | | | | | | | | Odometer |
|---|---|---|---|---|---|---|---|---|---|
| | ID | | | Fuel | | Oil Change | Tire | | Reading |
| Timestamp | Number | Make | Model | Level | | Performed | Pressure | | Miles |
| 5/6/2018 | 123456789 | Toyota | Prius | | | | | | |
| 12:00 | | | | | | | | | |
| 5/7/2018 | | | | 10.4 | gal | | 32.1 | psi | 37867 |
| 12:00 | | | | | | | | | |
| 5/7/2018 | | | | 8.2 | gal | | 32 | psi | 31965 |
| 14:40 | | | | | | | | | |
| 5/8/2018 | | | | 12 | gal | 4 qt | 31.8 | psi | 32823 |
| 13:30 | | | | | | synthetic | | | |
| 5/8/2018 | | | | 9 | gal | | 31 | psi | 32988 |
| 15:15 | | | | | | | | | |

Table 3 illustrates data that may be stored at a user database, such as the user database of databases 175 of FIG. 1. Table 3 contains information about users or drivers. The data of table 3 includes a first column identifies a type of data stored, a second column that contains a first user preference or credential, and a third column that contains a second user preference or credential. Data or types of preferences in table 3 include a name, a home address, a work address, preferred gasoline vendors, Facebook login information, Instagram login information, top or preferred general retailers, and a top or preferred coffee shop. Table 3 indicates that driver “Joe” lives at 123 State Street, has a work address of 456 Oak Avenue, prefers both Octan and Dinoco types of gasoline, prefers to shop at either Stop and Mom and Pops stores, and likes to drink JavaJavaJava coffee. Table 3 also stores Joe's Facebook Login information (Jsmith/******) and Instagram login information (Jsmith01/******). The information stored in table 3 may have been provided by Joe, when he was configuring user profile information. This information could be used by systems consistent with the present disclosure to provide recommendations to Joe. For example, when Joe's fuel level is low, Joe may be informed of a location of an Octan gas station where he may fill up his vehicle with gasoline. Furthermore, of Joe identifies that “I would like to get some coffee,” Joe may be provided with information that identifies a nearby location of a JaveJavaJava coffee shop near his location.

TABLE 3
User or Driver Database Data

| | User Credential- | User Credential |
|---|---|---|
| Data/Preference Type | Preference 1 | Preference 2 |
| Name | “Joe” | |
| Home Address | 123 State Street | |
| Work Address | 456 Oak Ave | |
| Gas Station Brand | Octan | Dinoco |
| Facebook Login | Jsmith/****** | |
| Instagram Login | Jsmith01/****** | |
| Top Visited General | Stop and Shop | Mom and Pops |
| Retailer | | |
| Top Visited Coffee Shop | JavaJavaJava | |

Table 4 illustrates information that may be stored in a use case database, such as the use case database of 190 of FIG. 1. The use case database of table 3 includes a first column that identifies command ID numbers, a second column that contains sample voice questions or requests that are associated with a given command, a third column that contains information/data relevant to the command, a fourth column that contains the results of a first action (e.g., action 1 result) that will be performed in association with the given command, a fifth column that contains the results of a second action (e.g., action 2 result) that will performed in association with the given command, a sixth column that contains the results of a third action (e.g., action 3 result) that will be performed in association with the given command, and a seventh column that contains the results of the fourth action (e.g., action 4 result) that will be performed in association with the given command. In response to a question of “what is my schedule?” the first row of FIG. 1 indicates that action results 1-3 include identifying that I have a meeting at 9 am at 123 Main Street, that traffic conditions are heavy and should result in an additional travel time of 10 to 12 minutes, and that a current fuel level of my vehicle is 2 gallons. A fourth action result of table 3 identifies that the vehicle AI agent system should recommend a departure time of 8:15 to be arrive at 123 Main Street by or before the meeting time of 9 am.

The data of table 4 identifies action results associated with the question of “do I need to stop for gas?” including identifying that the vehicle gas tank is currently storing 10 gallons of gas, that the average fuel usage of the vehicle is 25 miles per gallon (MPG), and that a maximum estimated travel distance that the vehicle can travel before running out of fuel is 250 miles.

TABLE 4
Use Case Database Data

| | | | | | | |
|---|---|---|---|---|---|---|
| | Sample | | | | | |
| | Voice | | Action 1 | Action 2 | Action 3 | Action 4 |
| CMD ID | Request | Data | Result | Result | Result | Result |

| | | | | | |
|---|---|---|---|---|---|
| 1 | “What is my | Schedule: | Traffic | Fuel | Recommended |
| | schedule?” | Meeting | Conditions: | Level = 2 | Departure |
| | | at 9am at | Traffic | Gallons | Time = 8:15 |
| | | 123 Main | Heavy; | | |
| | | Street | 10-12 | | |
| | | | additional | | |
| | | | minutes | | |
| | | | travel time | | |
| 2 | “Do I need | Fuel | Average | Maximum | |
| | to stop for | Level = 10 | MPG = 25 | Travel | |
| | gas?” | Gallons | | Distance = | |
| | | | | 250 Miles | |

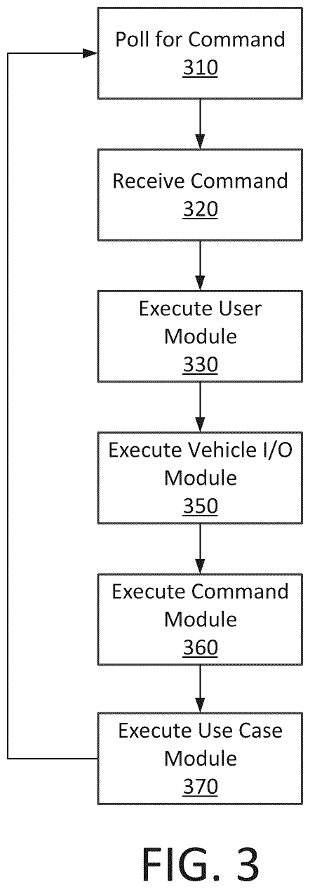

As mentioned above in respect to FIG. 1, apparatus consistent with the present disclosure may store instructions associated with various different software modules that may interact with each other. While FIG. 1 includes a base software module, a vehicle I/O software module, a user software module, a command software module, and a use case software module, methods consistent with the present disclosure may be implemented by fewer or more software modules that perform similar functions. Functioning of the “Base Module” will now be explained with reference to memory 150 of FIG. 1 and the steps FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 illustrates a series of steps that may be performed when instructions of a base software module are executed by processor of the vehicle AI agent of FIG. 1. As such, processor/CPU 145 of FIG. 1 may execute instructions out of memory 150 when performing functions of the base software module. The process begins with step 310 that polls or checks to see if a command has been received from the other system elements. A command may be received at step 320 of FIG. 3, next, after the command is received, instructions associated with a user software module may be executed in step 330 of FIG. 3. Instructions of the user module may be performed in parallel or in an interleaved fashion with the execution of instructions of other software modules, at step 330. Next in step 340, instructions of the vehicle I/O module may be executed followed by or coincident with execution of instructions of the command module in step 360, and execution of instructions of the use case module may be executed in step 370 of FIG. 3. As such, the base software module may receive commands and provide data to other software modules that perform functions associated with the command after which program flow may return to the base software module.

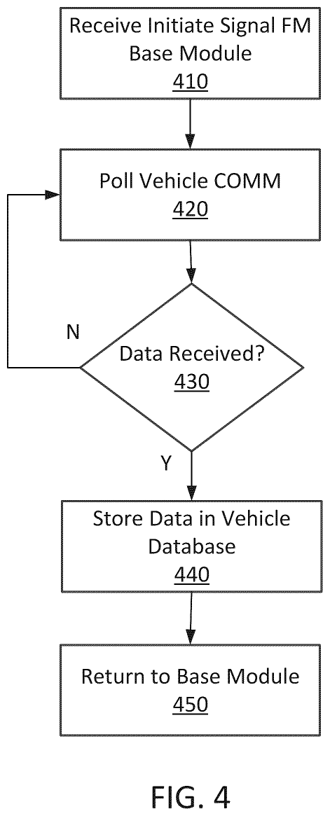

FIG. 4 illustrates steps that may be performed when instructions of the vehicle I/O module are executed by the processor of the vehicle AI agent of FIG. 1. As such, processor/CPU 145 of FIG. 1 may execute instructions out of memory 150 when performing functions of the vehicle I/O software module. The process begins with receiving a signal (or indication) to initiate steps of the vehicle I/O software module from the base software module at step 410 of FIG. 4. Next, in step 420 communications with the computer 110 of the vehicle 105 of FIG. 1 may be initiated via communication interface 120 and the cloud or Internet 135. Determination step 430 may then identify whether any sensor or other data was received from vehicle computer. When determination step 430 identifies that no data has been received from the vehicle computer program flow may move back to step 420 where the vehicle computer is polled for data again. When determination step 430 identifies that data has been received from the vehicle computer, program flow may move to step 440 where that data is stored in a database. As discussed previously, data that may be received from a vehicle computer may include a number of gallons of fuel in a vehicle fuel tank, measures of tire pressure, or a current vehicle odometer reading. After step 440, program flow may move back to executing instructions of the base software module in step 450 of FIG. 4.

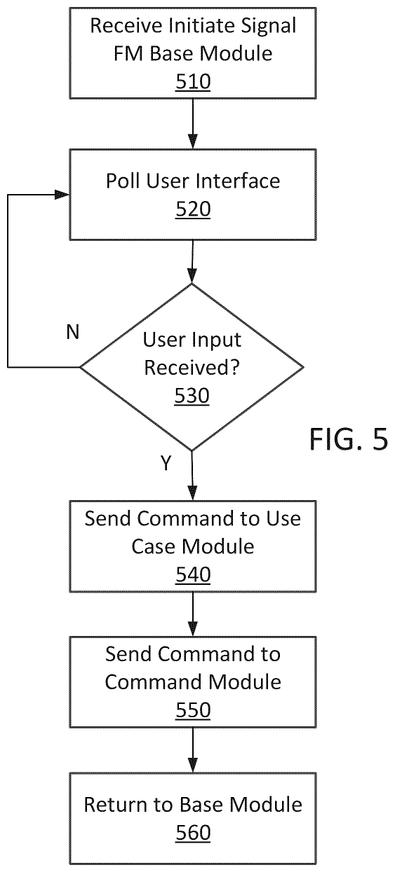

FIG. 5 illustrates steps that may be performed when instructions of the user software module are executed by the processor of the vehicle AI agent of FIG. 1. As such, processor/CPU 145 of FIG. 1 may execute instructions out of memory 150 when performing functions of the user software module. FIG. 5 begins with receiving a signal (or indication) to initiate its routine from the base software module, at step 510 of FIG. 5. At regular intervals, the user module may poll a user interface for a command at step 520. Such commands could have been received after a driver of a vehicle has provided a voice input or has provided an input via a touch screen at vehicle 105 of FIG. 1. Determination step 530 may identify whether any user input has been received, when no program flow may move back to step 520 where the user interface may be polled again. When determination step 530 identifies that user input has been received, program flow may move to step 540 where the command is provided to or sent to the use case software module. Next, program flow may move to step 550 where the command is provided or sent to the command module and the program flow may move back to the base module in step 560 of FIG. 5.

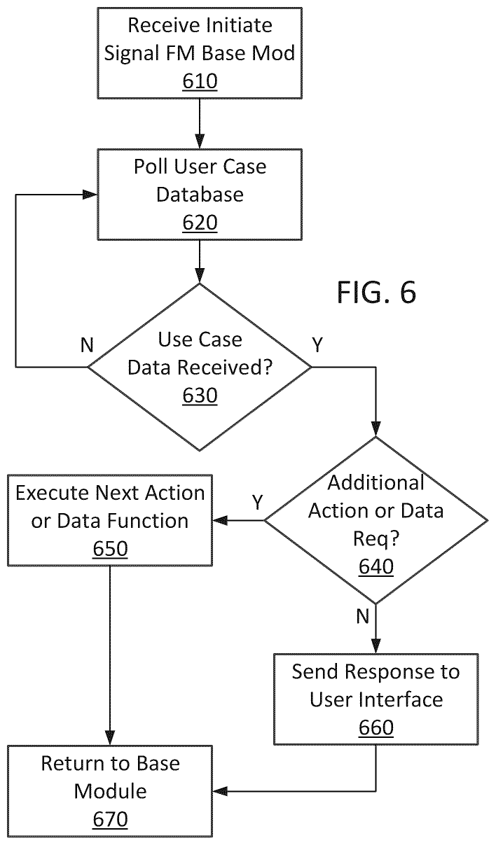

FIG. 6 illustrates operations that may be performed when instructions of the command software module are executed by the processor of the vehicle AI agent of FIG. 1. As such, processor/CPU 145 of FIG. 1 may execute instructions out of memory 150 of FIG. 1 when performing functions of the command software module. The process begins with receiving a signal (or indication) to initiate its routine from the base software module at step 610 of FIG. 6. Next in step 620 instructions of the command software module may cause processor/CPU 145 of the vehicle AI agent system to access or poll the use case database for relevant use case data. This may include, for example, retrieving daily appointments of a person in response to a command that requests schedule information as discussed in respect to table 4. CPU 145 of FIG. 1 may then retrieve calendar information from the use case database. Data retrieved from the use case database may identify a measure of fuel (number of gallons) that are currently in a vehicle fuel tank in response to a command that asks if the driver needs to stop for gas.

Determination step 630 may then identify whether any use case data was received based on the command, when no program flow may move back to step 620, where the use case database may be accessed or polled again. When determination step 630 identifies that use case data has been retrieved or received from the use case database, program flow may move to determination step 640 that identifies whether any additional action should be performed or whether any additional data is required to perform an action. As discussed in respect to the use case data of table 4, these additional actions may include checking traffic conditions, checking vehicle fuel levels, or identifying an average fuel consumption rate in MPG. When an additional action or data are required, program flow may move to step 650 where this additional action is performed or where additional data is retrieved. After step 650 program flow may move back to executing instructions of the base software module in step 670 of FIG. 6. When determination step 640 identifies that no additional actions or data is required, program flow may move from step 640 to step 660 where a response is sent to the user interface. Step 660 could, for example, cause messages to be sent from the vehicle AI agent system 140 to the vehicle computer 110 of FIG. 1. Those messages could then be provided to a driver of vehicle 105 via a user interface (e.g. a speaker or a display). Messages provided to the driver may identify any of the action results of table 4, such as the 9 am meeting at 123 main street, the heavy traffic conditions, a fuel level, a fuel economy (MPG), a maximum travel distance, or a recommended departure time. After step 660, program flow may move back to the base software module in step 670 of FIG. 6.

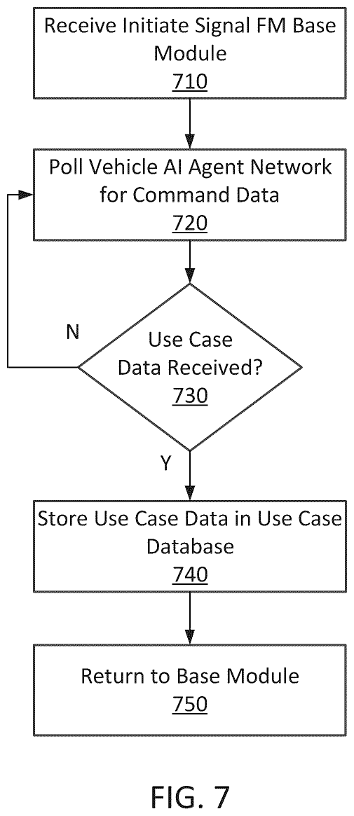

FIG. 7 illustrates steps that may be performed when instructions of a use case software module are executed by the processor of the vehicle AI agent of FIG. 1. FIG. 7 begins with receiving a signal to initiate its routine from the base software module at step 710 of FIG. 7. Next in step 720 instructions of the use case software module may cause a computer to poll the vehicle AI agent network 180 of FIG. 1 for data relevant to a specific command. For example, if the user requested information about their daily appointments, the vehicle AI agent would seek calendar data, as well as, for example, weather and traffic information and vehicle diagnostics. After step 720, determination step 730 may identify whether any data was received from the vehicle AI agent network, when no program flow may move back to step 720 where the vehicle AI agent network is polled for data once again. When determination step 730 identifies that use case data has been received, program flow may move to step 740 where that data is stored in the use case database. After step 740, program flow may move back to the base software module in step 750 of FIG. 7.

The data received in FIG. 6 may have been retrieved from the use case module database of vehicle AI agent system 140 and the data received in FIG. 7 may have been retrieved from the network use case database 190 of the vehicle AI agent network 180 of FIG. 1. As such, use case data may be retrieved from different sources when instructions associated with different software modules are executed. Alternatively or additionally, the memory of vehicle computer 110 may store use case data that can be retrieved when the vehicle AI agent system performs functions consistent with the present disclosure.

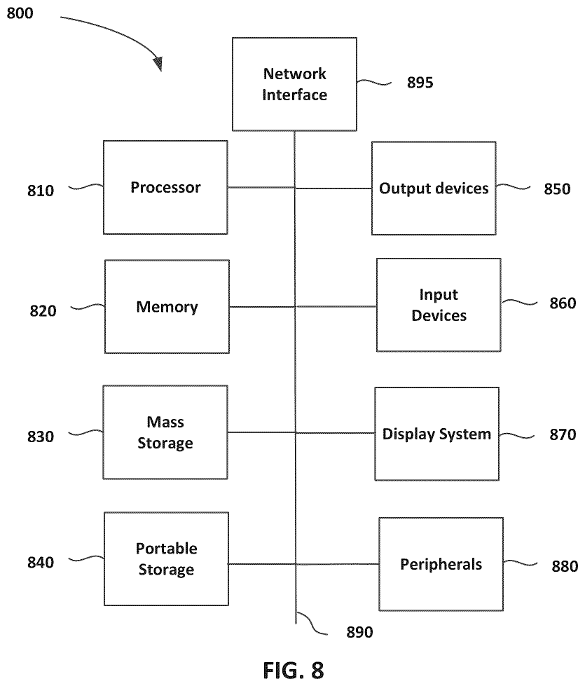

FIG. 8 illustrates a computing system that may be used to implement an embodiment of the present invention. The computing system 800 of FIG. 8 includes one or more processors 810 and main memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, peripheral devices 880, and network interface 895.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a FLASH memory, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 870 may include a liquid crystal display (LCD), a plasma display, an organic light-emitting diode (OLED) display, an electronic ink display, a projector-based display, a holographic display, or another suitable display device. Display system 870 receives textual and graphical information, and processes the information for output to the display device. The display system 870 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 880 may include any type of computer support device to add additional functionality to the computer system. For example, peripheral device(s) 880 may include a modem or a router.

Network interface 895 may include any form of computer interface of a computer, whether that be a wired network or a wireless interface. As such, network interface 895 may be an Ethernet network interface, a BlueTooth™ wireless interface, an 802.11 interface, or a cellular phone interface.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 800 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. An apparatus for route-based vehicle sensor evaluation, the apparatus comprising:
a sensor interface that receives sensor data from a plurality of sensors of a vehicle, wherein the sensor data includes measurements indicative of respective statuses of a plurality of components of the vehicle as captured by the plurality of sensors;
a positioning receiver that detects positions of the vehicle at different times;
an input device within the vehicle, wherein the input device receives input data that is associated with an interaction with the input device;
an output device within the vehicle, wherein the output device outputs a response;
a memory storing instructions; and
a processor that executes the instructions, wherein execution of the instructions causes the processor to:
interpret the input data to identify a query;
identify, based on the query, a sensor action, a network action, and an evaluation action to perform to support generation of a response to the query;
retrieve the sensor data through the sensor interface to perform the sensor action;
retrieve network data from a network data store to perform the network action, wherein the network data is associated with a route to be driven by the vehicle;
generate an estimate based on processing of the sensor data and the network data and the positions using an artificial intelligence network to perform the evaluation action, where the estimate is associated with the route; and
generate the response to the query, wherein the response is indicative of the estimate.

2. The apparatus of claim 1, wherein the execution of the instructions causes the processor to:
analyze visual data from the sensor data using a vision system to detect a change in an environment that the vehicle is in, wherein the plurality of sensors of the vehicle include a camera that captures the visual data, and wherein the estimate is based on the change in the environment.

3. The apparatus of claim 1, wherein the execution of the instructions causes the processor to:
analyze Light Detection and Ranging (LiDAR) data from the sensor data to detect a change in an environment that the vehicle is in, wherein the plurality of sensors of the vehicle include a LiDAR sensor that captures the LiDAR data, and wherein the estimate is based on the change in the environment.

4. The apparatus of claim 1, wherein the input device includes a touch interface of a touchscreen, wherein the input data includes a touch input detected using the touch interface of the touchscreen, wherein the output device includes a screen of the touchscreen, and wherein the output device outputs the response by displaying the response on the screen of the touchscreen.

5. The apparatus of claim 1, wherein the input device includes a microphone, wherein the input data includes a voice input recorded using the microphone, wherein interpreting the input data is based on a voice recognition system, wherein the output device includes a speaker, and wherein the output device outputs the response by playing the response through the speaker.

6. The apparatus of claim 1, wherein the execution of the instructions causes the processor to:
cause the vehicle to perform an action associated with the response.

7. The apparatus of claim 1, wherein the estimate is at least one of a recommended departure time for the route or an estimated arrival time for the route.

8. The apparatus of claim 1, wherein the network data identifies at least one of traffic conditions along the route, weather conditions along the route, or road conditions along the route.

9. The apparatus of claim 1, wherein the network data identifies a location of a merchant along the route, and wherein the estimate is associated with a stop along the route at the location of the merchant.

10. The apparatus of claim 1, wherein the execution of the instructions causes the processor to:
identify the route based on the sensor data and the network data, wherein the estimate is associated with a time during which the vehicle is to be driving the route.

11. The apparatus of claim 1, wherein the network data includes vehicle specifications associated with the vehicle, and wherein the estimate is based on the sensor data and the vehicle specifications.

12. A method for route-based vehicle sensor evaluation, the method comprising:
receiving input data through an input device within a vehicle, wherein the input data is associated with an interaction with the input device;
interpreting the input data to identify a query;
identifying, based on the query, a sensor action, a network action, and an evaluation action to perform to support generation of a response to the query;
retrieving sensor data from a plurality of sensors of the vehicle to perform the sensor action, wherein the sensor data includes measurements indicative of respective statuses of a plurality of components of the vehicle as captured by the plurality of sensors;
retrieving network data from a network data store to perform the network action, wherein the network data is associated with a route to be driven by the vehicle;
detecting positions of the vehicle at different times using a positioning receiver;
generating an estimate based on processing of the sensor data and the network data and the positions using an artificial intelligence network to perform the evaluation action, where the estimate is associated with the route;
generating the response to the query, wherein the response is indicative of the estimate; and
outputting the response through an output device within the vehicle.

13. The method of claim 12, further comprising:
analyzing visual data from the sensor data using a vision system to detect a change in an environment that the vehicle is in, wherein the plurality of sensors of the vehicle include a camera that captures the visual data, and wherein the estimate is based on the change in the environment.

14. The method of claim 12, further comprising:
analyzing Light Detection and Ranging (LiDAR) data from the sensor data to detect a change in an environment that the vehicle is in, wherein the plurality of sensors of the vehicle include a LiDAR sensor that captures the LiDAR data, and wherein the estimate is based on the change in the environment.

15. The method of claim 12, wherein the input device includes a touch interface of a touchscreen, wherein the input data includes a touch input detected using the touch interface of the touchscreen, wherein the output device includes a screen of the touchscreen, and wherein the output device outputs the response by displaying the response on the screen of the touchscreen.

16. The method of claim 12, wherein the input device includes a microphone, wherein the input data includes a voice input recorded using the microphone, wherein interpreting the input data is based on a voice recognition system, wherein the output device includes a speaker, and wherein the output device outputs the response by playing the response through the speaker.

17. The method of claim 12, further comprising:
causing the vehicle to perform an action associated with the response.

18. The method of claim 12, wherein the estimate is at least one of a recommended departure time for the route or an estimated arrival time for the route.

19. The method of claim 12, wherein the network data identifies at least one of traffic conditions along the route, weather conditions along the route, or road conditions along the route.

20. A non-transitory computer readable storage medium having embodied thereon a program, wherein the program is executable by a processor to perform a method of route-based vehicle sensor evaluation, the method comprising:
receiving input data through an input device within a vehicle, wherein the input data is associated with an interaction with the input device;
interpreting the input data to identify a query;
identifying, based on the query, a sensor action, a network action, and an evaluation action to perform to support generation of a response to the query;
retrieving sensor data from a plurality of sensors of the vehicle to perform the sensor action, wherein the sensor data includes measurements indicative of respective statuses of a plurality of components of the vehicle as captured by the plurality of sensors;
retrieving network data from a network data store to perform the network action, wherein the network data is associated with a route to be driven by the vehicle;
detecting positions of the vehicle at different times using a positioning receiver;
generating an estimate based on processing of the sensor data and the network data and the positions using an artificial intelligence network to perform the evaluation action, where the estimate is associated with the route;
generating the response to the query, wherein the response is indicative of the estimate; and
outputting the response through an output device within the vehicle.
